(19) United States
(12) Patent Application Publication
(10) Pub. No.: US 2007/0291580 A1
(43) Pub. Date: Dec. 20, 2007

(54) Remuage-riding machine

(76) Inventors: Oleg Naljolov, Brooklyn, NY (US); Aleksandra Grigoreva, Brooklyn, NY (US)

Correspondence Address: Oleg Naljolov, Apt 5D, 3130 Brighton 6th Street, Brooklyn, NY, 11235, US

(21) Appl. No.: 11/453,517

(22) Filed: Jun. 15, 2006

(51) Int. Cl. B01F 11/00

(52) U.S. Cl. 366/110; 366/214

(57) ABSTRACT

A riddling machine for intensification of depositing dead yeast cells (lees) in wine. One embodiment comprises a platform housing an engine and a transmission; supporting means, including rigid ribs, bearings on their tops, rotatably supporting a shaft; two discs mounted at the shaft's ends. A plurality of discs' holes holds cylindrical cases angularly placeable therein. The cases contain bottles with wine and lees, immovably and reversibly inserted therein. The discs are turned, revolving the cases intensifying the lees depositing to the bottlenecks. Some embodiments include vibrators actuating vibrations of the bottles, intensifying the depositing. Other embodiments have a modified expandable shaft to place the cases into the disc's holes at a predetermined angular direction common for all cases, thus tilting the platform orients all the bottles closer to the vertical, intensifying the depositing. The machine preferably includes a control unit programmably regulating the engine's turns, vibrations, and tilting.

### TECHNICAL FIELD

The present invention relates to the food industry, particularly to the wine industry, and can be used for the riddling stage of champagne production.

### BACKGROUND OF THE INVENTION

The traditional technology of champagne making, particularly described on the web page “http://www.champagne-ayala.fr/fabrication_eng.html#top” includes the following stages: pressing (the grapes are placed in special presses to yield their juice), winemaking (the first fermentation—transformation of sugar into alcohol), blending (blending wines from different vineyards and different harvests), bottling (the second fermentation—in the definite bottle), riddling or remuage (gathering the dead yeast cells or sediment, also known as lies or lees, which are formed during the bottling, and brought to the neck of the bottle during this stage), disgorgement (the bottle necks are frozen, trapping the sediments in a chunk of ice, the bottles are opened, and the sediments are expelled with the ice by the pressure in the bottle).

The riddling stage, intended to make the sediment deposit slide into the neck of the bottle, prescribes: “During 4 to 5 weeks the bottles are placed at a 45 degree angle, stored on racks and are handled, manually or automatically, about 40 times. They are regularly turned (an eighth or a forth of a turn) and progressively brought back up to a vertical position. The mechanical riddling can achieve this in about a week, while the manual riddling takes about one month.”

When Veuve Clicquot first developed the riddling system, every step was done by hand. The complete process took usually from six to eight weeks for a batch of about 5000 bottles. Some producers still use this hands-on method. After the second fermentation in the bottle, and after the aging period on the yeast sediment in the bottle, the bottles are taken from their resting place and inserted into large A-frame wooden racks, called pupitres, with the neck of the bottles pointing slightly downward. The sediment at this stage appears as a strip, with many of the dead yeast cells adhering to the side of the bottle. The riddler is to maneuver the sediment into manageable lump inside the bottle, and then bring the lees down of the bottle into the bottle neck, close to the crown cap closing the bottle.

In order to do this, the following steps are repeatedly performed on each bottle: the riddler manually grasps the bottom end of each bottle; shakes the bottle slightly to dislodge any stuck lees; turns the bottle approximately one-eighth of a turn; raises the bottom end of the bottle slightly; drops the bottle back into the hole in the rack. Such handling of the bottle gradually ousts the sediment into the neck of the bottle, at which point the bottle is almost completely inverted on the rack.

Many of champagne sparking wine producers use modern automated methods to riddle the wine. There are semi-automatic and automatic devices called “gyropalettes”, where a hexagonal metal basket with an inverted cone-shaped base is filled with inverted bottles and occasionally rotated from side to side.

In 1966, Adolf Heck invented and patented the first automatic riddling machine. Korbel has continued to improve upon Adolfs idea, and today it is possible to produce champagne of consistent high quality with the gyropalettes. According to Korbel, the bottled wine is placed upside down in shipping cases that are arranged on automatic riddling racks. These racks gently vibrate the bottles for one hour, four times a day. During the vibration, the cases are gently rocked every two minutes that eventually works the lees down into the neck of the bottle.

Computer-automated gyropalettes accomplish the riddling in batches, using movable bins containing thousands of bottles. Invented in Spain, they became common in all sparkling wine producing countries since the late 1970s. The mechanization allows for saving time, space and production cost for the producers. Hand riddling requires a minimum of eight weeks to complete, whereas the gyropalettes finish the task in less than ten days. This application of modern technology also increases product consistency from bottle to bottle. Production cost savings also has allowed the introduction of traditional method sparkling wines into the lower price end of the market where formerly only bulk produced wines competed.

A U.S. patent application Ser. No. 10/453074 filed on Jun. 3, 2003 (publication 20040244597 A1), now abandoned and incorporated hereby by reference in its entirety, discloses another equipment and technology for automation of the riddling process. A substantial part of that application's disclosure follows below with insignificant changes. Accordingly, all drawing figures with their unchanged respective numbers and reference numerals (also correspondingly indicated in the disclosure) of that abandoned application are attached hereto for the purpose of comparison with the present new invention described herein further.

There are known riddling equipments for champagne, which consist of a basis with a stage and operating system. The basis or platform can revolve on the axis and is designed for containers with bottles, which can be put on it (see French patents No 2473356, 1980, and No 8000891, 1981, classification C12G 1/06). These devices are labor-consuming, consist of many complex hinged joints and bearing units. Because the container with bottles weighs too much, high power-consuming engines are required.

However, all these complications make the plant bulky, metal- and power-consuming. The declared invention purposes reducing of metal- and power-consuming, enhancing of operating reliability and convenience, and guaranteeing the possibility to control the riddling process at any stage without a break.

This can be achieved as follows: the riddling equipment for champagne consists of a frame with at least one platform on it, which can revolve and an operating system which has an engine placed on the platform A container for bottles can be put on this platform According to the invention the platform includes two discs with holes; the discs are linked by a rod and installed on the frame; the holes are allocated on the discs area evenly, and every hole has a personal container for a bottle, which is designed as an open case with a ring on the open end. The operating system consists of a rope connected to the rod and the engine's roller that maintains to-and-fro motion of the rod during the roller forward and backward rotation.

The equipment depicted on FIGS. 1, 2, 3, and 4 has a frame (1), discs (2, 3) placed on the frame, a connecting rod (4). For the additional resistance of the construction the discs can be pinned together with several bolts (5). The discs have holes (6). Every hole has a bottle case (7) and a ring (8). Bottles (9) are placed into cases. The rings (8) are designed in order the case with a bottle could not fall out of the hole and for the bottle could revolve during the disc turns as there is frictional connection between the case and the disc. The following things are fixed on the frame: an electrical engine (10) on one side and a sheave (11) on the other side. There is a rope (12) that is put on the sheave and the engine's roller. The rope ends are fastened to the rod (4) opposite sides with the bearing (13) help, which bearing is placed on the rod. Besides, the rope is winded around the engine several times.

The equipment operates as follows: in the beginning the discs are on one end of the frame. Every bottle (9) is placed with the neck down in a case (7), which is located in the hole (6) of the discs (2) and (3). The greater part of the bottle is placed in the case. As the case diameter is less than the hole's diameter, so the bottles are placed at a particular angle. The angle value depends on the diameters proportions and the thickness of discs (2, 3). The ring (8) prevents the case with a bottle from falling out of the disc's hole (6).

Then the engine (10), partially shown on FIG. 2, is turned on and its roller begins to revolve. During the revolving the roller rewinds the rope (12) from one side to the other, and consequently moves the rod (4) and discs (2, 3) with bottles with the help of the bearing (13). The bearing is necessary in order the rope does not wind on the rod. The discs begin to roll (revolve) along the frame (1), and the cases (7) with the inserted bottles (9) also begin to revolve keeping the slant (inclined) position. The ring (8) of every case and the edge of the corresponding hole (6) form a reducer, thanks to which each case (7) with the bottle revolves on its axis with equal angular velocity; but this velocity is greater than the discs revolving velocity (when the disc makes one turn, all the bottles make 1.25 turn on their axis, and even more that depends on the hole and case diameters proportions).

During one working cycle the discs shift from one frame end to the other. This distance facilitates the discs 80-90 degrees rotation, and the engine stops operating. During this process the bottles will revolve on their axes 90-100 degrees, and the dead yeast cells will move into the neck. In several hours the engine will turn on with reversion, and the rope will move the discs to the initial position. So, the bottles will revolve again, and this movement will make the dead yeast cells shift into the bottle necks. Thus, the engine is turned on and off with reversion in certain time intervals, that leads to the dead yeast cells moving into the bottles necks. For the engine commutation a programmed timer can be used. When the riddling process is finished, the bottles are moved out of the cases and sent to undergo “disgorgement”, i.e. the next technological stage.

The cases can be produced in the form of transparent glasses with thin walls, or plastic covers which will have the bottle shape and notches (cutouts). In order to prevent the cases without the bottles from falling out of the holes, there could be designed a ferrule on the end of the case (it is not shown on the figures).

The disc diameters can be arbitrarily big in order the discs can hold a many bottles as possible (e.g. as shown on FIG. 8). To guarantee the necessary slant angle for bottles the disc should be thin enough (about 5 mm). If the disc thickness is more than 5 mm, then the hole should be cone-shaped, so the slant angle will not become less. For the construction resistance the disc can hold stiffening ribs between the holes, or be designed as compound (doubled) disc. If necessary, one engine can maintain the movement of several discs pairs at once, which can be joined with the help of bearings (13). The bearings of every discs pair should be fastened together by traction. Actually, there could be a frame for each discs pair, or one big shared frame.

As the invention of that abandoned application is now reviewed, it derives another problem: in each cycle of rolling of discs (2, 3), the engine stops the rotation, which causes inertial forces applied horizontally to the body of wine in the bottle toward the interrupted horizontal linear motion component (tending to continue that linear motion), and results in additional disturbance of the wine. This factor slows down the process of depositing the lees into the bottle's neck, and therefore prolongs the time of riddling. It is now believed that this problem can be solved by a principal alteration of the previous construction, which the present invention is dedicated to.

### BRIEF DESCRIPTION OF THE PRESENT INVENTION

A riddling machine for intensification of a process of depositing dead yeast cells in the wine technology is provided, according to the present invention. An embodiment of the machine comprises a base platform containing an engine; a transmission driving sheave coupled to the engine. The embodiment comprises supporting means, including rigid ribs mounted upon the platform, and bearings mounted on tops of the ribs. An elongated shaft substantially horizontally installed on the bearings. A transmission driven sheave mounted on the shaft providing its rotation when the engine is rotated. Two discs fixedly mounted substantially on the shaft's ends perpendicularly to its longitudinal axis. A plurality of holes are made in the discs' bodies. Bottles, containing wine with lees, are substantially immovably placed in cases, generally of cylindrical shape with notches or grooves. The cases are inserted into the holes in a reverse position, at an angle to the horizon. The discs are turned as required, resulting in revolving the cases and intensification of lees depositing down to the bottle neck.

Some embodiments may include a vibrator actuating vibrations of the discs, holding the cases with the bottles, additionally intensifing the depositing process. The machine preferably includes a control unit regulating the engine's turns and the vibrations according to a program. Other embodiments may have a modified shaft made expandable to facilitate the placement of the cases into the disc's holes at a predetermined angle. If all the cases are placed in the same angular position relative to the vertical direction, any horizontal tilt (also preferably regulated by the control unit) of the platform may equally change this angular position, including substantially close to the vertical direction, which is required at certain times by the wine technology for intensifying the depositing process.

### BRIEF DESCRIPTION OF THE DRAWINGS

FIG. 1, pertaining to the invention of the abandoned application, shows the assembled representation of the riddling equipment for champagne (for simplicity the disc is shown only with one case with a bottle).

FIG. 2, pertaining to the invention of the abandoned application, shows the side representation of the equipment.

FIG. 3 and FIG. 4, pertaining to the invention of the abandoned application, show the different stages of the operating mode (for simplicity the disc is shown only with one case with a bottle).

FIGS. 5a, b, pertaining to the invention of the abandoned application, show the case with a bottle in two foreshortenings.

FIG. 6, pertaining to the invention of the abandoned application, shows the case without a bottle.

FIG. 7, pertaining to the invention of the abandoned application, shows the case modification which is designed as a cover.

FIG. 8, pertaining to the invention of the abandoned application, shows the disc construction designed for a greater number of bottles.

FIG. 9 illustrates a side sectional view of the riddling machine, according to the present invention.

FIG. 10 illustrates a frontal view VI-VI of the riddling machine, according to the present invention.

FIG. 11 illustrates a partial sectional view of a modification of the riddling machine in a horizontal position, according to the present invention.

FIG. 12 illustrates a partial sectional view of a modification of the riddling machine in a tilted position, according to the present invention.

Generally, the same reference numerals refer to the same elements of construction on different figures.

### DESCRIPTION OF THE PREFERRED EMBODIMENT OF PRESENT INVENTION

While the invention may be susceptible to embodiment in different forms, there is shown in the drawings, and will be described in detail herein, specific embodiments of the present invention, with the understanding that the present disclosure is to be considered an exemplification of the principles of the invention, and is not intended to limit the invention to that as illustrated and described herein.

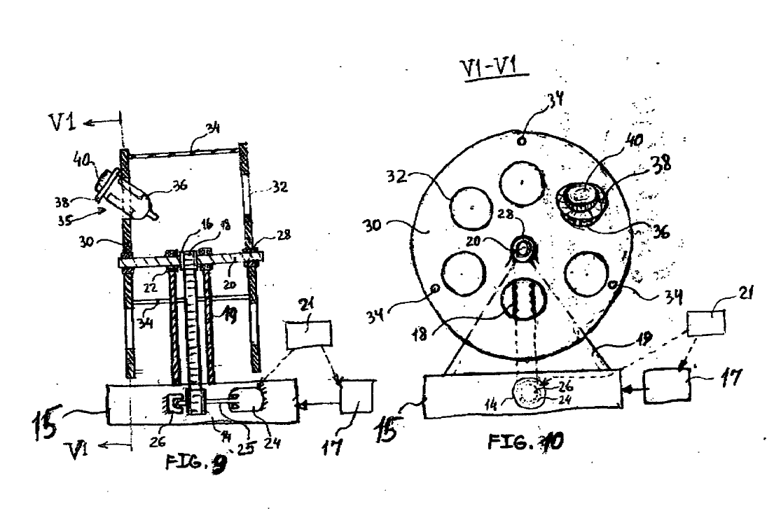

Referring to the drawings in more detail, illustrated on FIGS. 9 and 10, an embodiment of the riddling machine comprises: a platform (15); two substantially triangularly shaped and sufficiently rigid supporting ribs (19), essentially vertically mounted on platform (15) in parallel planes; two supporting bearings (22), mounted on the tops of ribs (19); a shaft (20) installed substantially horizontally and supported by bearings (22), which bearings in general positioned equidistantly from the center of the longitudinal axis of shaft (20); two naves (28) fixedly mounted substantially at the ends of shaft (20), in general positioned equidistantly from the center of the longitudinal axis of shaft (20); two discs (30) mounted on naves (28) substantially in two vertical planes parallel to each other.

The embodiment of the riddling machine comprises an engine (24) fixedly mounted inside platform (15), an electrical motor of suitable parameters or another conventional power means can be utilized for this purpose; a driving shaft (25) mounted substantially horizontally, one end of which driving shaft is coupled to and rotatable by engine (24), whereas the second end of the driving shaft is rotatably supported by a step-bearing (26) fixedly mounted inside platform (15); a driving sheave (14) is fixed on driving shaft (25).

The embodiment of the riddling machine comprises a driven sheave (16) fixed on shaft (20), positioned substantially at the center of the longitudinal axis of shaft (20); a transmission endless belt (18) passing the rotation from driving sheave (14) to driven sheave (16), as shown on FIG. 9. Any conventional belt of suitable parameters may be utilized for this purpose.

The embodiment of the riddling machine comprises a vibrator (17), capable to actuate vibrations, required by the technology, of platform (15). The vibrator (17) is conditionally reflected on FIGS. 9 and 10 by a rectangular box with an arrow pointing to platform (15). The riddling machine in general comprises a control unit (21), schematically illustrated on FIGS. 9 and 10 by a rectangular box. Control unit (21) is configured to control the rotation of engine (24) and the vibrations of vibrator (17), according to a program developed based on the technological requirements of champagne production for actuating necessary turns of discs (30) and vibrations of vibrator (17) at predetermined time points.

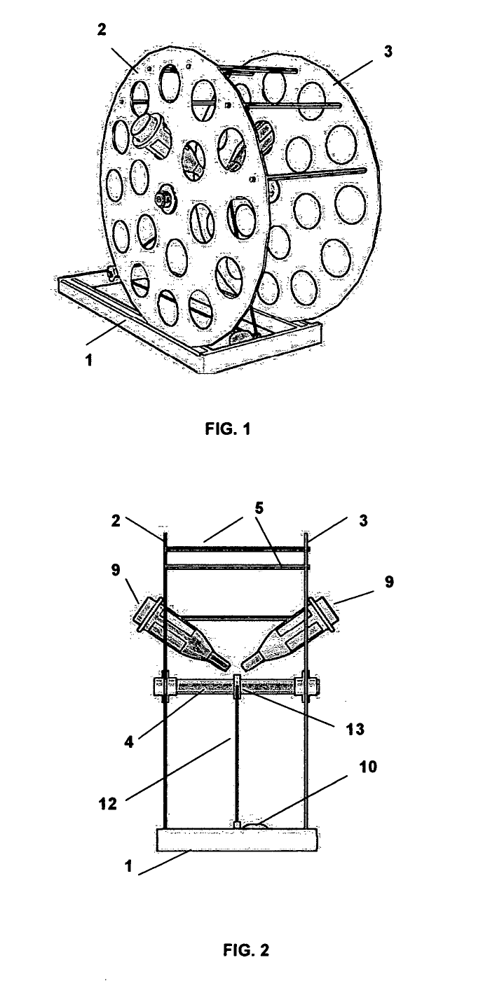

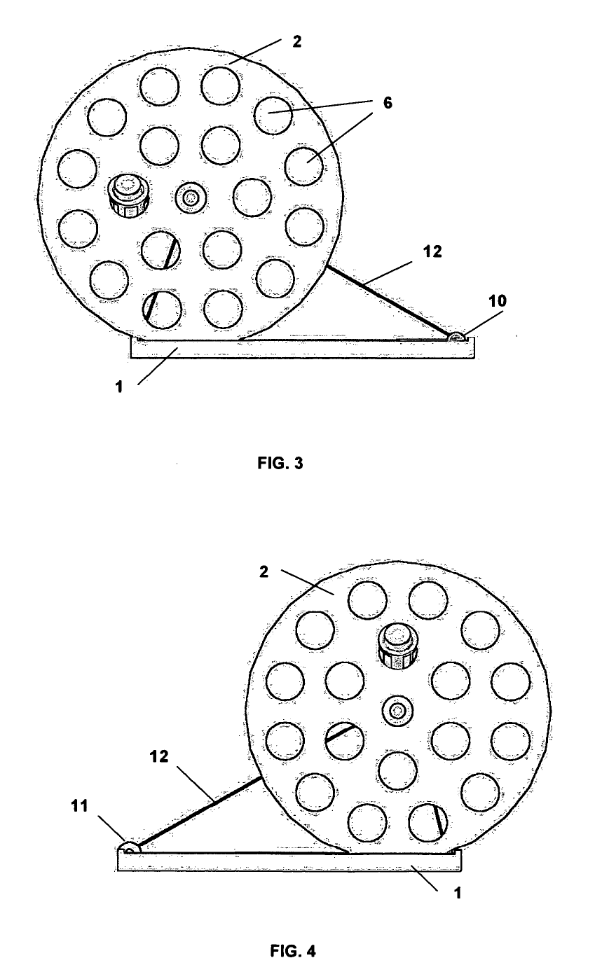

Discs (30) are performed similar to discs (2 and 3) described above and shown on FIGS. 1, 2, 3, and 4. Discs (30) contain a number of holes (32). FIG. 10 exemplarily shows six such holes (32) evenly allocated on each of the discs (30), substantially equidistantly from the centers of the discs. Of course, other variations of holes allocations can be used (e.g. depicted on FIG. 8) where appropriate. Discs (30) may be preferably attached to each other by rigid rods (34), e.g. disposed at a 120 degree angle (less than the maximum angle of the disc turn) relatively to each other, as illustrated on FIG. 10.

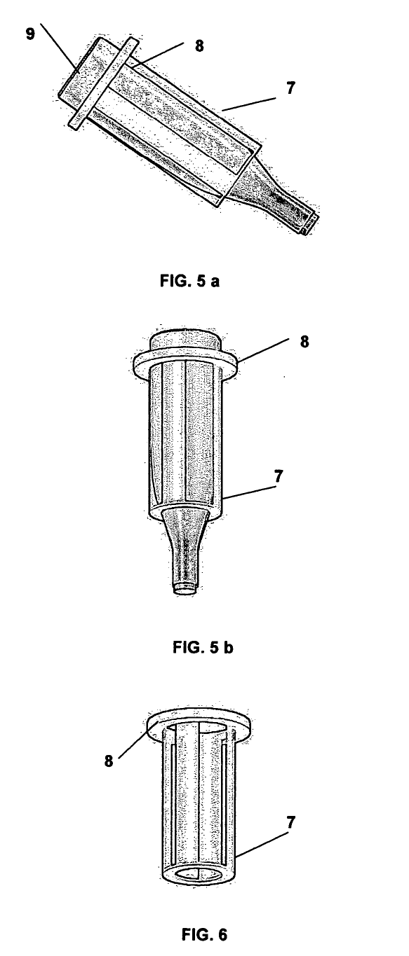

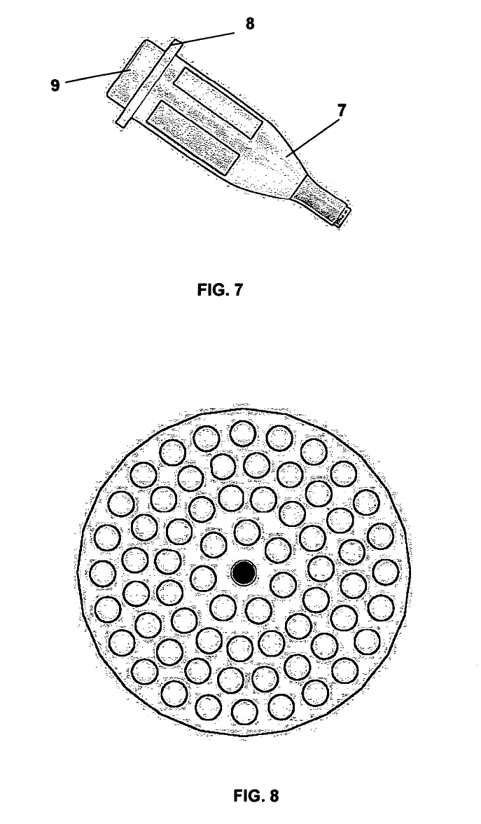

The embodiment of the riddling machine comprises cases (35), (similar to cases (7) described above in the previous invention), insertable in disc holes (32) generally in a reversed position (i.e. the bottom of the bottle is positioned higher than the neck of the bottle) at a predetermined angle. One case (35) is exemplarily depicted on FIG. 9. Each hole (32) may contain one case (35), which includes a substantially cylindrical case body (36) with notches or grooves on the external surface of the sidewalls, and a ring (38) similar to the ring (8) shown on FIGS. 5a, 5b, 6. The interaction between the disc hole (32) and, on the other hand, ring (38) in the upper contact point and case body (36) in the lower contact point, depends upon the configuration of the case body and the hole, the thickness of discs (30), the relationship between the diameters of case (35) and hole (32), the materials of the discs and the cases. The kinematical relations, including the angular velocities, of the cases and the disc holes are described above.

The operation of the riddling machine, according to the present invention, though somewhat similar to the equipment operation of the previous invention described above and in the abandoned application, is in fact different, and provides a novel feature. Discs (30), revolving on shaft (20), are engaged in a rotational motion only, which does not carry a horizontal linear movement component, as it was in the previous invention. The above-mentioned interaction between the disc hole and the case however does not generally change. As a result, the wine in the bottle is not essentially subjected to an interruption of the linear movement, and this allows avoiding an additional disturbance caused by linear inertial forces arising in such interruption, and acting upon the wine.

In the previous invention, the wine tends to continue moving linearly in the direction of the motion just interrupted, and this actuates the additional disturbance (forward and backward waves in the liquid) of the wine, taking place in the previous equipment construction (illustrated on FIGS. 1, 2, 3, and 4), which disturbance may undesirably prolong the time of depositing the dead yeast cells during the riddling stage of champagne process.

In the present invention, an essential component of the inertial force applied to the wine is substantially radially directed from the center of disc (30) (i.e. the center of rotation) to the most remote from the center bottle's sideline, extended along the bottle's sidewall parallel to its longitudinal axis. The inertial force represents a centrifugal force developed within a liquid body in a rotational motion, and it tends to push the lees to said sideline. At the moment of interruption of the rotation a decelerating tangent force is added to the centrifugal force, which results in a resultant force. When the resultant force discontinues, and a portion of the lees, substantially collected along the sideline, tends to slide down into the bottle neck, which should speed up the riddling stage.

According to the present invention, the exemplary embodiment of the riddling machine, shown on FIG. 9 and 10, operates as follows: control unit (21) launches engine (24), which rotates driving shaft (25) and driving sheave (14). By means of belt (18), the rotation is transmitted to driven sheave (16), and discs (30). Case (35) revolves due to the frictional contact of its ring (38) and its body (36) with the disc body contact points at the corresponding hole (32) holding the case (35). Thus, discs (30) are turned at a predetermined angle and with a predetermined time intervals, regulated by control unit (21). Following the discs, cases (35) revolve at another angle (generally greater than the discs turn angle) within the same time intervals.

The control unit (21) also actuates vibrator (17), causing vibrations of platform (15), ribs (19), shaft (20), discs (30), cases (35), and bottles (40) filled with wine. The revolving and vibrations provide the above-described conditions for depositing of the lees downward into the bottle neck.

Different embodiments and variations of the above disclosed riddling machine may be designed and built. For example, shaft (20) may be modified and made expandable (e.g. telescopically). In such a case it would be convenient to insert bottles in the holes of all the discs positioned on the shaft in parallel, i.e. in one axial orientation (the space between the discs would allow that). The insertion of bottles should take place when the shaft is expanded from its normal state. Then the shaft is returned from its expanded state into the normal state and fixed therein. The discs become close to each other, which saves the space around them during operation.

An embodiment with the expandable shaft modification is illustrated on FIG. 11. The riddling machine comprises a platform (15) mounted on footings (23L) and (23R). Ribs (19) are mounted on platform (15). Bearings (22), mounted on tops of ribs(19), support a central shaft (20C) substantially shaped as a tube, a left shaft (20A) and a right shaft (20B) both substantially made as solid elongated cylinders. Shafts (20A) and (20B) are capable to be inserted and snug-fitting into shaft (20C), and capable to be expanded from shaft (20C). In the inserted (normal) state, shafts (20A) and (20B) may be fixed with conventional fixing means (not shown on FIG. 11). FIG. 11 shows the shafts in the expanded state. Cases (35) are placed into holes (32) of the left and right discs (30) at a predetermined angle “alpha”.

The expandable construction of the shaft may enable tilting the platform with the discs at an angle (e.g. by rising one its side, so that the shaft 20 would be oriented not horizontally, but inclined to the opposite side, which is not risen). The tilting may generally be arranged by the use of at least three lifting footings supporting the platform. Rising one or two of such footings would provide the necessary tilt angle of the platform in relation to the horizontal plane. This would alter the bottles orientation relative to the vertical direction, which is one of the riddling requirements. Also such an expandable shaft may accommodate more than two discs. An example follows.

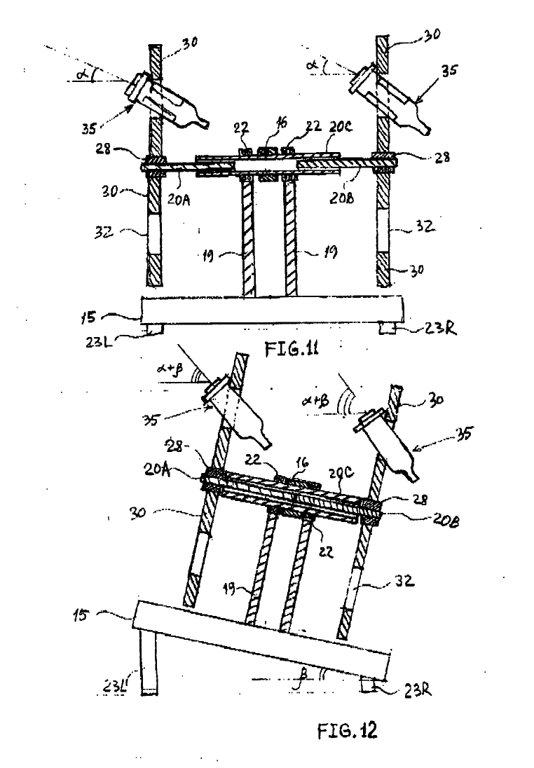

The above described embodiment, wherein platform (15) was illustrated on FIG. 11 in its horizontal state, implementing two lifting footings (23L) and two lifting footings (23R), is now reflected on FIG. 12. It shows the front footing (23L) and (23R). Shafts (20A) and (20B) are inserted into shaft (20C), and secured by fixed means, e.g. bolts and nuts (27). The left pair of footings (23L) is lifted; the right pair of footings (23R) is in its initial lowest position. This causes platform (15) to change its horizontal state to the titled state, inclining from the left to the right at a predetermined angle “beta” to the horizontal plane. As a result, angle “alpha”, at which cases (35) were placed into holes (32) on FIG. 11, now increases and is equal to “alpha plus beta” (which angle may have a predetermined a value up to a maximal value required by the riddling technology), as shown on FIG. 12. Thus, the embodiment allows altering the position of cases (35) with bottles of wine to an angle position substantially close to the vertical direction.

Another conventional type of transmission means may be implemented instead of the “sheave—belt—sheave” (14-18-16) type exemplarily described earlier herein. The above-discussed triangular ribs 19 might also be substituted by different supporting means.

We claim:

1. A riddling machine for intensification of a process of depositing dead yeast cells, said riddling machine comprising:
supporting means;
an engine means fixedly supported by said supporting means;
transmission means fixedly supported by said supporting means and actuated by said engine means;
a shaft preferably horizontally mounted on said supporting means;
at least two discs rotatably mounted on said shaft in vertical parallel planes, said discs including a plurality of holes made in the bodies of said discs;
a plurality of cases insertable into said holes at a predetermined angle, said cases being in a frictional contact with said discs in contact points located in proximity of the edges of said holes, said cases capable to be rotated when the discs being rotated, said cases capable to contain and hold bottles in a reversed position, said bottles capable to contain wine undergoing the riddling process;
wherein the rotation of the cases with bottles providing said intensification of the depositing process.

2. The riddling machine according to claim 1, further comprising
vibration means actuating vibrations of said discs;
control means regulating said engine and vibration means; wherein
said bottles capable to be vibrated when the vibration means actuating said vibrations; and
the vibrations additionally providing said intensification of the depositing process.

3. The riddling machine according to claim 2, wherein
said shaft performed expandable, facilitating the inserting of said cases with wine bottles into all the holes of the machine's discs uniformly and substantially at a predetermined angle relatively to the vertical direction.

4. The riddling machine according to claim 3, wherein
said supporting means further including a platform capable to be tilted changing the position of said shaft from a substantially horizontal normal position to an inclined position, providing an alteration of the angle of the longitudinal axis of all the bottles placed in the discs holes of the riddling machine, enabling to dispose the bottles at a predetermined maximum angle, substantially close to the vertical direction, thereby additionally providing said intensification of the depositing process.
